(19) United States
(12) Patent Application Publication
(10) Pub. No.: US 2015/0074613 A1
(43) Pub. Date: Mar. 12, 2015

(54) Menus with Hand Based Gestures

(71) Applicant: Nicholas Frederick Oswald, Redondo Beach, CA (US)

(72) Inventor: Nicholas Frederick Oswald, Redondo Beach, CA (US)

(21) Appl. No.: 14/022,230

(22) Filed: Sep. 10, 2013

(51) Int. Cl. G06F 3/0488

(52) U.S. Cl. CPC G06F 3/0488
USPC 715/863

(57) ABSTRACT

Several embodiments that allow for more precise three dimensional control of menus within electronic interfaces that may include televisions, computers, tablets, and smartphones. Interaction with electronic interfaces may be made through devices that measure three dimensional interaction such as the Leap Motion controller and Oculus Rift headset.

### BACKGROUND OF THE INVENTION

The following is a tabulation of some prior art that presently appears relevant:

U.S. Patents

| Pat. No. | Publication Date | Patentee |
|---|---|---|
| 5,805,167 | Sep. 8, 1998 | Cruyningen |
| 2003001340 A2 | Jan. 3, 2003 | Kirill Mosttov, John Vermes |
| 20100185989 | Jul. 22, 2010 | Palm, Inc. |
| 20100192102 | Jul. 29, 2010 | IBM Corporation |

Gesture based computing is in many consumer devices today. However, most of these implementations have been centered around touch-based gestures or simple motion gestures on devices such as mobile phones and tablets. Just as mechanical switches and buttons have become slowly replaced by these gestures, other gestures such as the implementation within this document, could offer further acceptance and usability by the public in electronic devices and in particular, consumer devices.

On many smartphones today, consumers can pinch-to-zoom to change the text and screen size of their window, they can swipe left or right to go through a photo album or to the next window, and can highlight text by placing their finger onto the screen for a few seconds. None of these implementations, however, use the full three dimensional aspect of a hand, but rather only use a finger or two to control the device.

Based on the lack of many three-dimensional gestures, there needs to be an improvement in how people can control their electronic devices. Gestures can be far more useful than current technologies used to control electronics and can thereby help bring these devices to a larger segment of the current population.

### SUMMARY OF THE INVENTION

In accordance with one embodiment an electronic motion sensing device connected to a computer and display processes a person's hand when changing said hand from a fist to an open hand by displaying a menu. When said hand closes and becomes a fist again, said menu disappears.

In accordance with another embodiment an electronic motion sensing device connected to a computer and display opens and closes multiple menus when a hand is partially opened between that of a fist and a fully open position.

In accordance with another embodiment an electronic motion sensing device connected to a television can turn a television on when a person opens their hand and turns it off when the person closes their hand into a fist.

In accordance with another embodiment an electronic motion sensing device connected to a security system within a house can be turned on by closing one's hand into a fist. To unsecure said system, an open hand combined with a security password can be used, both for added security and enhanced ease of use.

In accordance with another embodiment a smartphone, with an embedded motion sensing device, can revert to the main menu by changing one's hand into a fist position.

In accordance with another embodiment a smartphone, with an embedded motion sensing device, can close all applications currently running by closing one's hand into a fist.

In accordance with another embodiment a toilet or urinal, with an embedded motion sensing device, can be controlled to flush by moving one's hand from an open to closed fist position within the field of said motion sensing device.

### BRIEF DESCRIPTION OF THE DRAWINGS

FIG. 1 is a flowchart depicting what would happen within the program as a gesture is being recognized by both the hardware and software. FIG. 1 assumes that an individual's hand is open before placed within the gesture device's field of range.

FIG. 2 is a flowchart depicting what would happen within the program as a gesture is being recognized by both the hardware and software. FIG. 2 assumes that an individual's hand is closed before placed within the gesture device's field of range.

FIG. 3 is a view of a hand in a fully open position.

FIG. 4 is a view of a hand with an opening of approximately 135 degrees between palm and fingers.

FIG. 5 is a view of a hand with an opening of approximately 90 degrees between palm and fingers.

### DETAILED DESCRIPTION—FIRST EMBODIMENT

In one embodiment of the gesture, a user is in front of an electronic motion sensing device connected to a computing device and a display. Said user closes one of their hands into a fist position and then places said hand within range of said motion sensing device. Said hand is then opened completely, allowing 180 degrees between fingers and palm of said hand (FIG. 3). Once said hand is opened, a menu appears on said display.

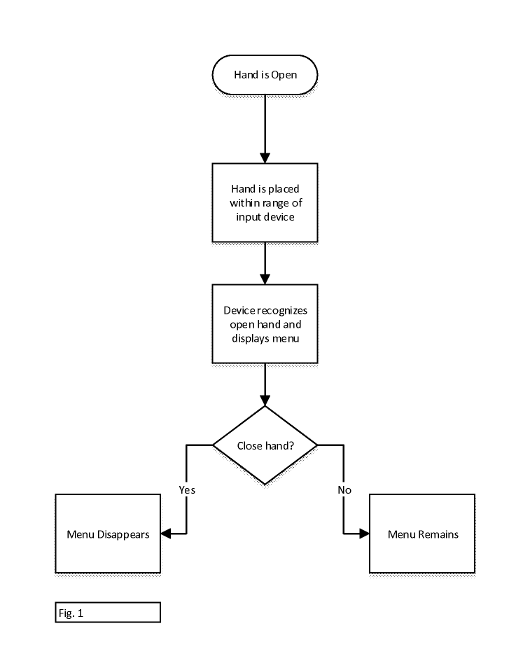

FIG. 1 describes the machine and computer logic which takes place in the detailed description of this embodiment.

### DETAILED DESCRIPTION—SECOND EMBODIMENT

In one embodiment of the gesture, a user is in front of an electronic motion sensing device connected to a computing device and a display. A menu is open on said display. Said user opens one of their hands, allowing 180 degrees between fingers and palm of said hand (FIG. 3). Once said hand is closed into a first, said menu disappears from said display.

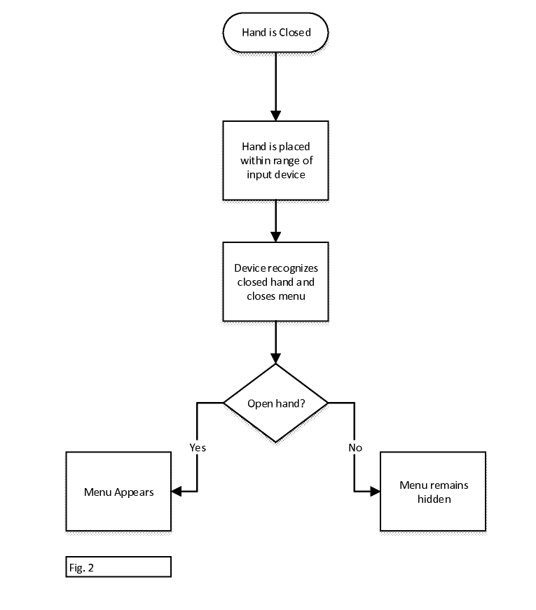

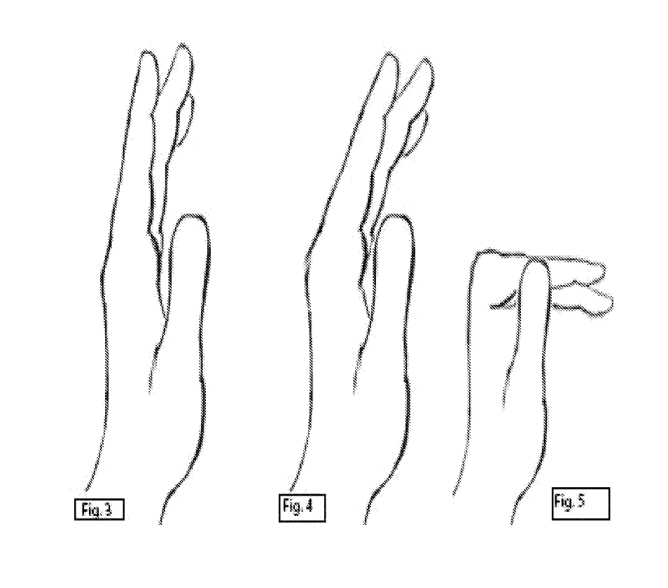

FIG. 2 describes the machine and computer logic which takes place in the detailed description of this embodiment.

### DETAILED DESCRIPTION—THIRD EMBODIMENT

In one embodiment of the gesture, a user is in front of a television. Said television is connected to an electronic motion sensing device. Said television is currently powered off. Said user closes one of their hands into a fist. Said hand is then placed within the sensing range of said electronic motion sensing device. Said hand is then opened into a position allowing 180 degrees between fingers and palm (FIG. 3). Once said hand is opened in said manner, the television is powered on. While said hand is still open and within range of said electronic motion sensing device, said hand is closed into a fist. When this occurs, said Television powers off.

### DETAILED DESCRIPTION—FOURTH EMBODIMENT

In one embodiment of the gesture, a user is in front of a security system control panel. Said security system is currently unarmed and connected to an electronic motion sensing device. Said user opens one of their hands, thereby allowing 180 degrees of space between fingers and palm (FIG. 3). Said user then positions said hand within range of said electronic motion sensing device. Said hand is changed into a fist position. Said security system is changed into an armed state. While said hand is still within range of said electronic motion sensing device and in a fist position, said hand is changed into an open position with 180 degrees of space between fingers and palm (FIG. 3). Said security system prompts said user for a password. If said user provides a correct password, said security system reverts to an unarmed state. If said user provides an incorrect password, then said security system maintains an armed state.

### DETAILED DESCRIPTION—FIFTH EMBODIMENT

In one embodiment of the gesture, a user is in front of a smartphone. Said smartphone contains an embedded electronic motion sensing device. Said smartphone is currently turned on. Said user closes one of their hands into a fist and then places said hand within sensing range of said electronic motion sensing device. Said hand is then opened into a position allowing 180 degrees between fingers and palm (FIG. 3). Once said hand is opened in said manner, a menu appears on said smartphone. While said hand is still open and within range of said electronic motion sensing device, said hand is closed into a fist. When this occurs, said Menu disappears.

### DETAILED DESCRIPTION—SIXTH EMBODIMENT

In one embodiment of the gesture, a user is in front of a smartphone. Said smartphone contains an embedded electronic motion sensing device. Said smartphone is currently turned on. Said user opens one of their hands into a position allowing 180 degrees of space between fingers and palm (FIG. 3) and then places said hand within sensing range of said electronic motion sensing device. Said hand is then closed into a fist position. Once said hand is closed in said manner, all applications currently open on said smartphone are now closed (eg. terminated and no longer consuming CPU and memory resources).

### CONCLUSION, RAMIFICATION, SCOPE

The reader will see that, according to the first embodiment of the invention, a user will be able to control their electronic device with a hand and fist gesture for basic navigation within a program.

While the above description contains many specificities, these should not be construed as limitations on the scope of any embodiment, but as exemplifications of various embodiments thereof. Many other ramifications and variations are possible within the teachings of the various embodiments. For example,

Thus the scope should be determined by the appended claims and their legal equivalents, and not by the examples given.

1. A method of controlling an electronic device comprising:
a. a computer processor,
b. a display connected to said computer processor,
c. an electronic motion sensing device connected to said display and said computer processor,
d. one or several hand gestures comprising a fist, an open hand, and a partially opened hand used to control said processor and said display in controlling menus.

2. A method of controlling an electronic device according to claim 1 and also containing one or more of the following attributes:
a. when said hand initially is open and changes to said fist, said menu closes on said display.
b. when said hand initially is in said fist state and opens to said open hand state, said menu appears.
c. when said hand initially is open and changes to said fist, said menu powers off said computer processor or said display or both.
d. when said hand initially is in said fist state and opens to said open hand state, said computer processor or said display or both power on.

3. A method of controlling an electronic device according to claim 1 and also containing one or more of the following attributes:
a. said electronic device is used to secure digital or physical property
b. when said hand initially is open and changes to said fist, said electronic device changes to an armed state
c. when said hand initially is in said fist state and opens to said open hand state, said electronic device prompts user for passcode, upon which entered successfully, said electronic device is changed to an unarmed state.
